(19) United States
(12) Patent Application Publication
(10) Pub. No.: US 2025/0105557 A1
(43) Pub. Date: Mar. 27, 2025

(54) CONNECTOR HOUSING ASSEMBLY, CONNECTOR AND CONNECTOR ASSEMBLY

(71) Applicant: Tyco Electronics (Shanghai) Co., Ltd., Shanghai (CN)

(72) Inventors: Jianfei (Fencer) Yu, Shanghai (CN); Guoqiang (David) Li, Shanghai (CN); Yong (Chris) Wang, Shanghai (CN); Xinzheng (Tony) Fan, Shanghai (CN); Daokuan (Jeremy) Zhang, Shanghai (CN)

(73) Assignee: Tyco Electronics (Shanghai) Co., Ltd., Shanghai (CN)

(21) Appl. No.: 18/895,536

(22) Filed: Sep. 25, 2024

(30) Foreign Application Priority Data
Sep. 25, 2023 (CN) 202311249925.5

(51) Int. Cl. H01R 13/631; H01R 13/502; H01R 13/74

(52) U.S. Cl. CPC H01R 13/6315; H01R 13/502; H01R 13/748

(57) ABSTRACT

A connector housing assembly includes a first housing having a first flange installed on a first installation panel, the first flange has a first mounting hole, a first support member installed in the first mounting hole and having a first through-hole that extends along an axial direction of the first mounting hole, a first elastic ring fitted on the first support member and radially compressed between the first support member and an inner circumferential surface of the first mounting hole, and a first connecting member passing through the first through-hole and connectable to the first installation panel. There is a first radial gap between the first support member and the inner circumferential surface of the first mounting hole when the first housing is installed on the first installation panel, allowing the first housing to float radially relative to the first connecting member.

### CROSS-REFERENCE TO RELATED APPLICATION

This application claims the benefit of the filing date under 35 U.S.C. § 119 (a)-(d) of Chinese Patent Application No. 202311249925.5, filed on Sep. 25, 2023.

### FIELD OF THE INVENTION

The present invention relates to a connector housing assembly, a connector comprising the connector housing assembly and a connector assembly comprising the connector.

### BACKGROUND OF THE INVENTION

Due to an installation position error between a male connector and a female connector, a central axis of the male and female connectors may not align, resulting in a certain radial error. At this point, if the male and female connectors are forcibly mated together, it will cause damage or even cracking to the housings of the male and female connectors.

### SUMMARY OF THE INVENTION

A connector housing assembly includes a first housing having a first flange installed on a first installation panel, the first flange has a first mounting hole, a first support member installed in the first mounting hole and having a first through-hole that extends along an axial direction of the first mounting hole, a first elastic ring fitted on the first support member and radially compressed between the first support member and an inner circumferential surface of the first mounting hole, and a first connecting member passing through the first through-hole and connectable to the first installation panel. There is a first radial gap between the first support member and the inner circumferential surface of the first mounting hole when the first housing is installed on the first installation panel, allowing the first housing to float radially relative to the first connecting member.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector and a mating connector according to an exemplary embodiment;

FIG. 2 shows an axial sectional view of a connector and a mating connector according to an exemplary embodiment, wherein the connector and mating connector have not yet been mated;

FIG. 3 shows an axial sectional view of a connector and a mating connector according to an exemplary embodiment, wherein the connector and mating connector have been mated;

FIG. 4 shows an illustrative exploded sectional view of a connector according to an exemplary embodiment;

FIG. 5 shows a planar sectional view of a connector according to an exemplary embodiment;

FIG. 6 shows an illustrative exploded sectional view of a mating connector according to an exemplary embodiment; and

FIG. 7 shows a planar sectional view of a mating connector according to an exemplary embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

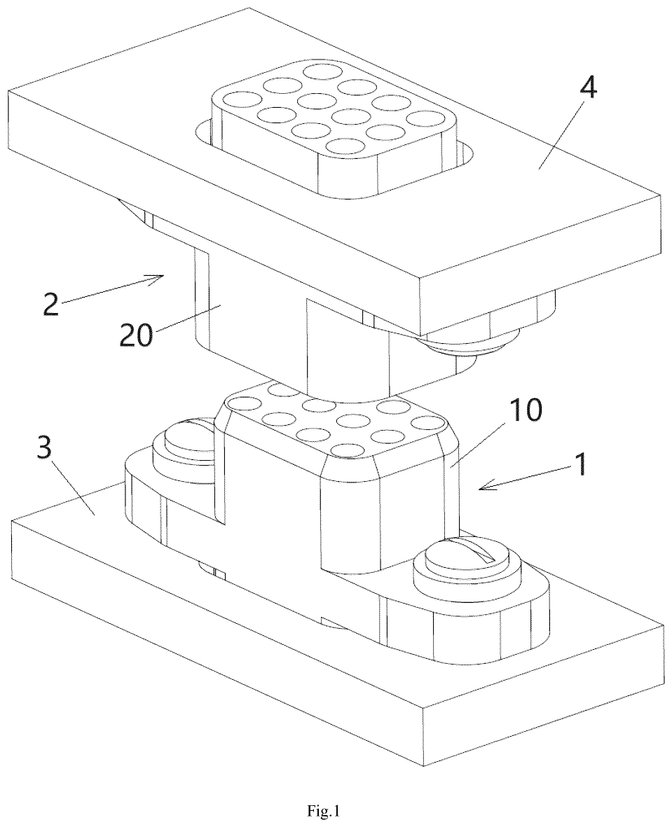

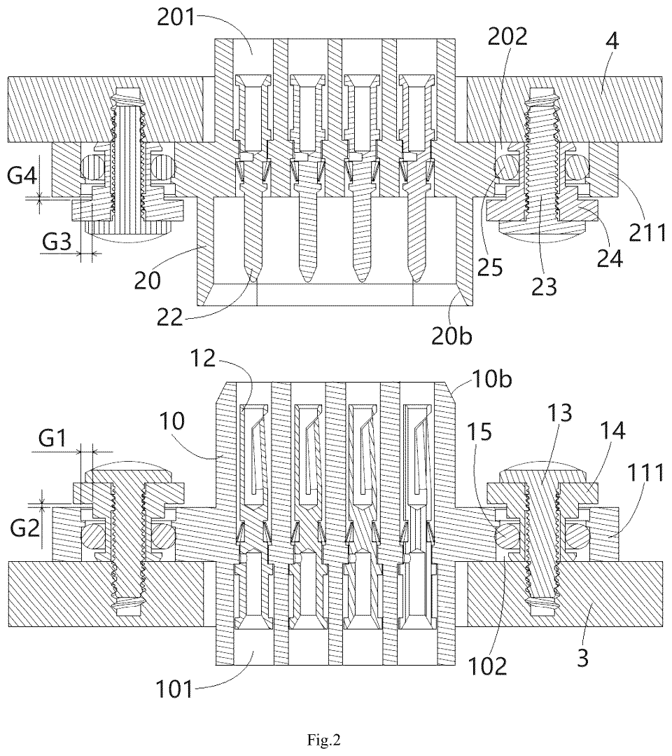

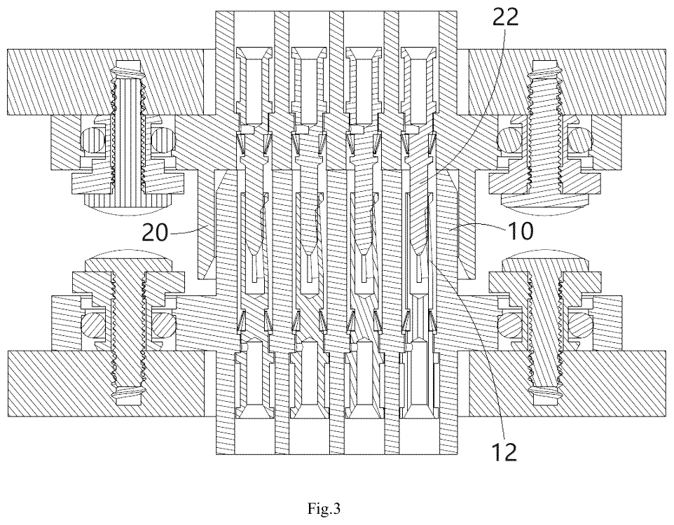

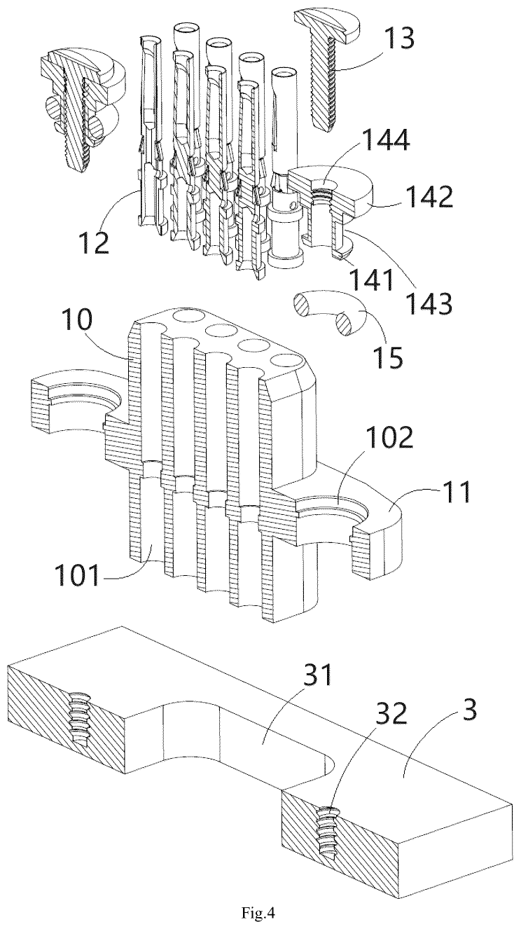

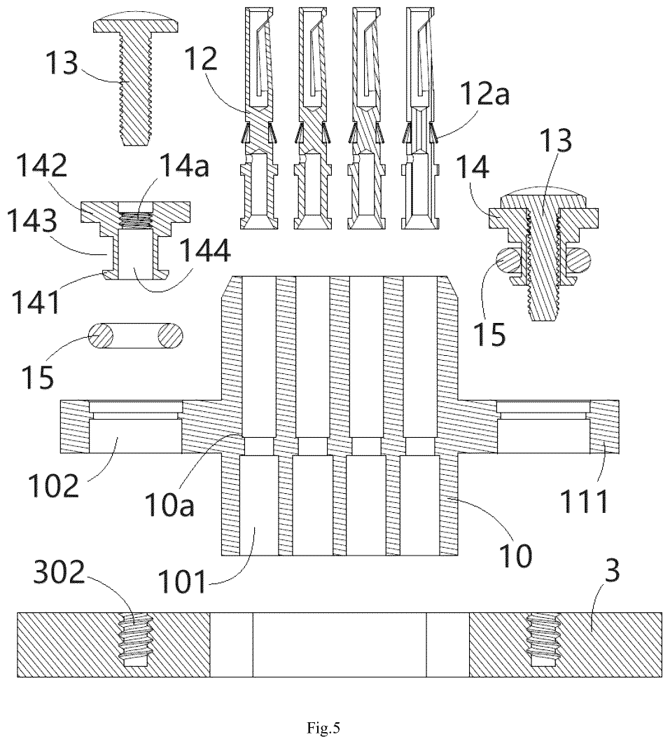

FIG. 1 shows an illustrative perspective view of connector 1 and mating connector 2 according to an exemplary embodiment. FIG. 2 shows an axial sectional view of connector 1 and mating connector 2 according to an exemplary embodiment, wherein connector 1 and mating connector 2 are not yet mated. FIG. 3 shows an axial sectional view of connector 1 and mating connector 2 according to an exemplary embodiment of the present invention, wherein connector 1 and mating connector 2 have been mated. FIG. 4 shows an illustrative exploded view of a connector 1 according to an exemplary embodiment. FIG. 5 shows a planar sectional view of connector 1 according to an exemplary embodiment.

As shown in FIGS. 1 to 5, in an exemplary embodiment of the present invention, a connector housing assembly is also disclosed. The connector housing assembly includes a first housing 10, a first support member 14, a first elastic ring 15, and a first connecting member 13. The first housing 10 comprises a first flange 111 which is installed on a first installation panel 3. A first mounting hole 102 is formed in the first flange 111. The first support member 14 is installed in the first mounting hole 102 and formed with a first through-hole 144 that extends along the axial direction of the first mounting hole 102. The first elastic ring 15 is assembled on the first support member 14 and is radially compressed between the first support member 14 and the inner circumferential surface of the first mounting hole 102. The first connecting member 13 passes through the first through-hole 144 and is connectable to the first installation panel 3.

As shown in FIG. 2, in the illustrated embodiments, when the first housing 10 is installed on the first installation panel 3, there is a first radial gap G1 between the first support member 14 and the inner circumferential surface of the first mounting hole 102, allowing the first housing 10 to float radially relative to the first connecting member 13. In the illustrated embodiment, when the first housing 10 is radially floating relative to the first connecting member 13, the first housing 10 is offset towards one side of the first connecting member 13 by compressing the first elastic ring 15, so that the central axis of the first mounting hole 102 is radially distant from the central axis of the first connecting member 13 by a predetermined distance.

As shown in FIG. 2, when the first housing 10 is installed on the first installation panel 3, the first support member 14 is spaced from the first flange 111 by a first axial gap G2 in the axial direction of the first mounting hole 102 to allow the first housing 10 to float radially and axially relative to the first connecting member 13.

As shown in FIGS. 2, 4, and 5, in the illustrated embodiments, when the first housing 10 is installed on the first installation panel 3, one end 141 of the first support member 14 is pressed against the first installation panel 3, and the other end 142 of the first support member 14 is separated from the first flange 111 by the first axial gap G2. In the illustrated embodiments, the first support member 14 has a first neck 143 located between its two ends 141 and 142, and the first elastic ring 15 is sleeved on the first neck 143 of the first support member 14 for centrally positioning the first support member 14 in the first mounting hole 102.

As shown in FIGS. 2, 4, and 5, in the illustrated embodiments, the first connecting member 13 is a threaded piece suitable for threaded connection with the first threaded hole 302 formed in the first installation panel 3. A first internal thread 14a suitable for threaded connection with the first connecting member 13 is formed in the first through-hole 144 of the first support member 14.

In the illustrated embodiments, when the first housing 10 is installed on the first installation panel 3, the end face of one end 141 of the first support member 14 is pressed against the first installation panel 3, and the head of the first connection member 13 is pressed against the end face of the other end 142 of the first support member 14, so that the first support member 14 is fastened to the first installation panel 3.

As shown in FIGS. 4 and 5, in the illustrated embodiments, a first terminal hole 101 is formed in the first housing 10 for inserting a first terminal 12, and a first step portion 10a is formed in the first terminal hole 101. The first step portion 10a rests against a first locking spring 12a of the first terminal 12 to lock the first terminal 12 in the first terminal hole 101.

In another exemplary embodiment of the present invention, a connector is also disclosed. The connector includes: the aforementioned connector housing assembly and a first terminal 12. The first terminal 12 is inserted into the first terminal hole 101 of the first housing 10, as shown in FIG. 2.

As shown in FIGS. 2 and 5, in the illustrated embodiments, the first terminal 12 has a first locking spring 12a, and the first step portion 10a in the first terminal hole 101 is pressed against the first locking spring 12a of the first terminal 12 to lock the first terminal 12 in the first terminal hole 101.

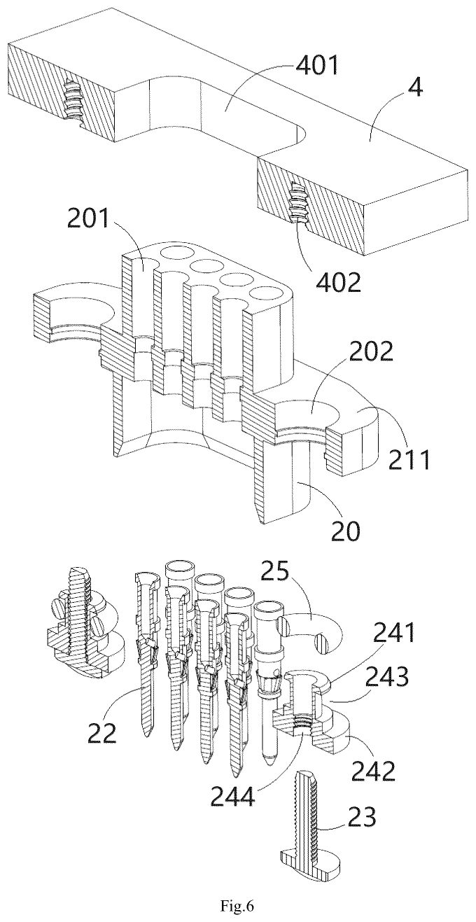

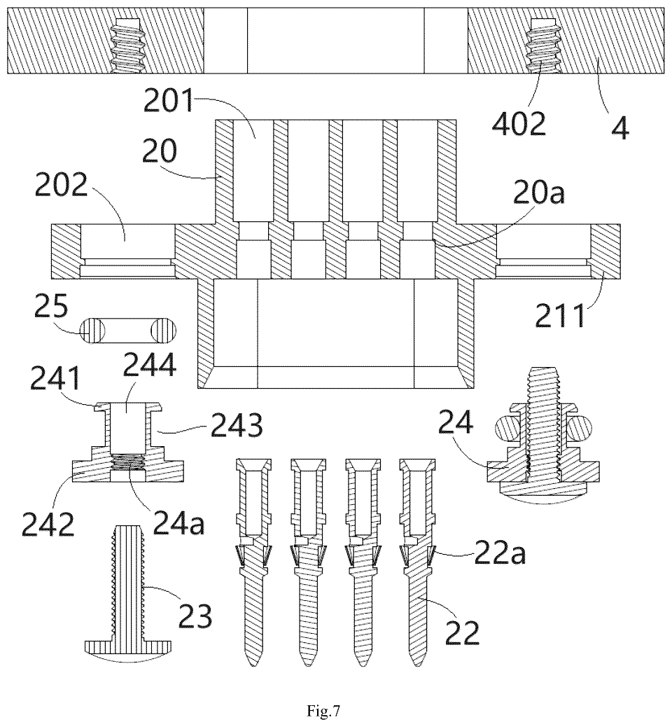

FIG. 6 shows an illustrative exploded view of the mating connector 2 according to an exemplary embodiment of the present invention. FIG. 7 shows a planar sectional view of the mating connector 2 according to an exemplary embodiment of the present invention.

As shown in FIGS. 1 to 7, in another exemplary embodiment of the present invention, a connector assembly is also disclosed. This connector assembly includes: the connector 1 and a mating connector 2. The mating connector 2 is mated with the connector 1.

As shown in FIGS. 2, 3, 6, and 7, in the illustrated embodiments, the mating connector 2 comprises a second housing 20 and a second terminal 22. The second housing 20 is formed with a second terminal hole 201 and is suitable for mating with the first housing 10. The second terminal 22 is inserted into the second terminal hole 201 and is suitable for mating with the first terminal 12.

In the illustrated embodiments, the connector 1 is a female connector, the first terminal 12 is a female terminal, the mating connector 2 is a male connector, and the second terminal 22 is a male terminal. When the connector 1 is mated with the mating connector 2, a portion of the first housing 10 is inserted into the second housing 20, and a portion of the second terminal 22 is inserted into the first terminal 12.

As shown in FIG. 2, in the illustrated embodiments, a first guide slope 10b is formed on the outer side of one end of the first housing 10, and a second guide slope 20b is formed on the inner side of one end of the second housing 20. The first guide slope 10b is mated with the second guide slope 20b to guide the first housing 10 into the second housing 20.

As shown in FIGS. 2, 6, and 7, in the illustrated embodiments, the second housing 20 has a second flange 211 for installation on a second installation panel 4, and a second mounting hole 202 is formed in the second flange 211. The mating connector 2 includes: a second support member 24, a second elastic ring 25, and a second connecting member 23. The second support member 24 is installed in the second mounting hole 202 and formed with a second through-hole 244 that extends along an axial direction of the second mounting hole 202. The second elastic ring 25 is mounted on the second support member 24 and is radially compressed between the second support member 24 and the inner circumferential surface of the second mounting hole 202. The second connecting member 23 passes through the second through-hole 244 and is suitable for connection to the second installation panel 4.

As shown in FIG. 2, in the illustrated embodiments, when the second housing 20 is installed on the second installation panel 4, there is a second radial gap G3 between the second support member 24 and the inner circumferential surface of the second mounting hole 202, allowing the second housing 20 to float radially relative to the second connecting member 23.

As shown in FIG. 2, when the second housing 20 is installed on the second installation panel 4, the second support member 24 is spaced from the second flange 211 by a second axial gap G4 in the axial direction of the second mounting hole 202 to allow the second housing 20 to float radially and axially relative to the second connecting member 23. In the illustrated embodiments, when the second housing 20 is installed on the second installation panel 4, one end 241 of the second support member 24 is pressed against the second installation panel 4, and the other end 242 of the second support member 24 is separated from the second flange 211 by the second axial gap G4.

As shown in FIGS. 6 and 7, in the illustrated embodiments, the second support member 24 has a second neck 243 located between its two ends 241 and 242, and the second elastic ring 25 is sleeved on the second neck 243 of the second support member 24 for centrally positioning the second support member 24 in the second mounting hole 202. In the illustrated embodiments, the second connecting member 23 is a threaded piece suitable for threaded connection with the second threaded hole 402 formed in the second installation panel 4. A second internal thread 24a suitable for threaded connection with the second connecting member 23 is formed in the second through-hole 244 of the second support member 24.

As shown in FIGS. 2 and 3, in the illustrated embodiments, when the second housing 20 is installed on the second installation panel 4, the end face of one end 241 of the second support member 24 is pressed against the second installation panel 4, and the head of the second connection member 23 is pressed against the end face of the other end 242 of the second support member 24, so that the second support member 24 is fastened to the second installation panel 4.

In the aforementioned exemplary embodiments of the present invention, the housing of the connector can float radially, thus absorbing a significant installation position error and ensuring smooth mating of the connector and mating connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector housing assembly, comprising:
a first housing having a first flange installed on a first installation panel, the first flange has a first mounting hole;
a first support member installed in the first mounting hole and having a first through-hole that extends along an axial direction of the first mounting hole;
a first elastic ring fitted on the first support member and radially compressed between the first support member and an inner circumferential surface of the first mounting hole; and
a first connecting member passing through the first through-hole and connectable to the first installation panel, there is a first radial gap between the first support member and the inner circumferential surface of the first mounting hole when the first housing is installed on the first installation panel, allowing the first housing to float radially relative to the first connecting member.

2. The connector housing assembly according to claim 1, wherein, when the first housing is installed on the first installation panel, the first support member is spaced from the first flange by a first axial gap in the axial direction of the first mounting hole to allow the first housing to float radially and axially relative to the first connecting member.

3. The connector housing assembly according to claim 2, wherein, when the first housing is installed on the first installation panel, an end of the first support member is pressed against the first installation panel, and another end of the first support member is separated from the first flange by the first axial gap.

4. The connector housing assembly according to claim 3, wherein the first support member has a first neck located between its ends, the first elastic ring is sleeved on the first neck of the first support member and centrally positions the first support member in the first mounting hole.

5. The connector housing assembly according to claim 1, wherein the first connecting member is a threaded piece having a threaded connection with a first threaded hole formed in the first installation panel, a first internal thread forming a threaded connection with the first connecting member is formed in the first through-hole of the first support member.

6. The connector housing assembly according to claim 5, wherein, when the first housing is installed on the first installation panel, an end face of the first support member is against the first installation panel, and a head of the first connecting member is against another end face of the first support member, the first support member is fastened to the first installation panel.

7. The connector housing assembly according to claim 1, wherein a first terminal hole is formed in the first housing and receives a first terminal, a first step portion is formed in the first terminal hole, the first step portion rests against a first locking spring of the first terminal to lock the first terminal in the first terminal hole.

8. A connector, comprising:
a connector housing assembly, including:
a first housing having a first flange installed on a first installation panel, the first flange has a first mounting hole;
a first support member installed in the first mounting hole and having a first through-hole that extends along an axial direction of the first mounting hole;
a first elastic ring fitted on the first support member and radially compressed between the first support member and an inner circumferential surface of the first mounting hole; and
a first connecting member passing through the first through-hole and connectable to the first installation panel, there is a first radial gap between the first support member and the inner circumferential surface of the first mounting hole when the first housing is installed on the first installation panel, allowing the first housing to float radially relative to the first connecting member; and
a first terminal inserted into a first terminal hole of the first housing.

9. The connector according to claim 8, wherein the first terminal has a first locking spring, a first step portion inside the first terminal hole is pressed against a first locking spring of the first terminal to lock the first terminal in the first terminal hole.

10. A connector assembly, comprising:
a connector, including:
a connector housing assembly, having:
a first housing having a first flange installed on a first installation panel, the first flange has a first mounting hole;
a first support member installed in the first mounting hole and having a first through-hole that extends along an axial direction of the first mounting hole;
a first elastic ring fitted on the first support member and radially compressed between the first support member and an inner circumferential surface of the first mounting hole; and
a first connecting member passing through the first through-hole and connectable to the first installation panel, there is a first radial gap between the first support member and the inner circumferential surface of the first mounting hole when the first housing is installed on the first installation panel, allowing the first housing to float radially relative to the first connecting member; and
a first terminal inserted into a first terminal hole of the first housing; and
a mating connector mated with the connector.

11. The connector assembly according to claim 10, wherein the mating connector includes:
a second housing having a second terminal hole and matable with the first housing; and
a second terminal inserted into the second terminal hole and matable with the first terminal.

12. The connector assembly according to claim 11, wherein the connector is a female connector, the first terminal is a female terminal, the mating connector is a male connector, and the second terminal is a male terminal, and when the connector is mated with the mating connector, a portion of the first housing is inserted into the second housing and a portion of the second terminal is inserted into the first terminal.

13. The connector assembly according to claim 12, wherein a first guide slope is formed on an outer side of an end of the first housing, and a second guide slope is formed on an inner side of an end of the second housing, the first guide slope is mated with the second guide slope to guide the first housing into the second housing.

14. The connector assembly according to claim 11, wherein the second housing has a second flange installed on a second installation panel formed with a second mounting hole, the mating connector includes:
a second support member installed in the second mounting hole and having a second through-hole that extends along an axial direction of the second mounting hole;
a second elastic ring fitted on the second support member and radially compressed between the second support member and an inner circumferential surface of the second mounting hole; and
a second connecting member passing through the second through-hole and connecting to the second installation panel.

15. The connector assembly according to claim 14, wherein, when the second housing is installed on the second installation panel, there is a second radial gap between the second support member and the inner circumferential surface of the second mounting hole, allowing the second housing to float radially relative to the second connecting member.

16. The connector assembly according to claim 15, wherein, when the second housing is installed on the second installation panel, the second support member is spaced from the second flange by a second axial gap in the axial direction of the second mounting hole to allow the second housing to float radially and axially relative to the second connecting member.

17. The connector assembly according to claim 16, wherein, when the second housing is installed on the second installation panel, an end of the second support member is pressed against the second installation panel, and another end of the second support member is separated from the second flange by the second axial gap.

18. The connector assembly according to claim 17, wherein the second support member has a second neck between the ends, the second elastic ring is sleeved on the second neck of the second support member and centrally positions the second support member in the second mounting hole.

19. The connector assembly according to claim 14, wherein the second connecting member is a threaded piece having a threaded connection with a second threaded hole formed in the second installation panel, a second internal thread having a threaded connection with the second connecting member is formed in the second through-hole of the second support member.

20. The connector assembly according to claim 19, wherein, when the second housing is installed on the second installation panel, an end face of the second support member is against the second installation panel, and a head of the second connecting member is against another end face of the second support member, the second support member is fastened to the second installation panel.
